(19) United States
(12) Patent Application Publication
(10) Pub. No.: US 2015/0065146 A1
(43) Pub. Date: Mar. 5, 2015

(54) COMMUNICATION WITH A MOBILE VIRTUAL BASE STATION

(71) Applicant: Swisscom AG, Bern (CH)

(72) Inventor: Daniel Wenger, Uttigen (CH)

(21) Appl. No.: 14/472,861

(22) Filed: Aug. 29, 2014

(30) Foreign Application Priority Data
Aug. 30, 2013 (EP) 13182320.5

(51) Int. Cl. H04W 36/32; H04W 36/00

(52) U.S. Cl. CPC H04W 36/32; H04W 36/0016; H04W 84/005
USPC 455/440

(57) ABSTRACT

Methods and systems are provided for using virtual base stations in communication systems. An example communication system may comprise a plurality of fixed base stations. A first fixed base station in a communication system may be used to transmit signals of a virtual base station. A second fixed base station in the communication system may then be selected on the basis of the location and/or of the movement of a group of mobile devices that are connected with a virtual base station; and transmission of the signals of the virtual base station may be switched from the first fixed base station to the second fixed base station.

### CLAIM OF PRIORITY

Pursuant to 35 U.S.C. §119, this patent application claims the filing date benefit of and right of priority to European (EP) Patent Application No. 13182320.5, filed Aug. 30, 2013. The above application is hereby incorporated herein by reference in its entirety.

### FIELD

The present disclosure relates to communications methods and systems. More specifically, certain embodiments of the present disclosure relate to methods and systems for communication with a mobile virtual base station.

### BACKGROUND

Connection quality in modern mobile radio communication has greatly improved in recent years. There are, however, still situations in which difficulties may arise in setting up connections, in maintaining the connections and/or in terms of quality of the connections. This is the case for example in transportation based user scenarios, such as in trains. Trains carry a large number of mobile communication devices, corresponding to (typically) large number of passengers or other persons (e.g., crew) on the trains. Due to the speed, each mobile communication device in the train has to incessantly organize a transfer of the connection to the next base station. This not only puts a great strain on the mobile communication device and the existing connection, it also places a very heavy burden on the mobile network every time the train enters the area covered by a new base station. In such a situation, a large number of mobile communication devices may nearly simultaneously request a transfer of connections to the same base station. The base station must therefore be designed for loads that far exceed the average load. Further, there are many applications that may be run in modern mobile devices, which may not stable in the context of a connection transfer to the next base station.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE DISCLOSURE

A system and/or method is provided for communication with a mobile virtual base station, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

Various features and advantages of the disclosure will become apparent from the following description of non-limiting exemplary embodiments, with reference to the appended drawings, in which:

FIG. 1 illustrates a view of an example communication system;

FIG. 2 illustrates an example control device of a communication system, in accordance with the present disclosure;

FIG. 3 illustrates an alternate example control device of a communication system, in accordance with the present disclosure; and

FIG. 4 is a flow chart illustrating an example process, in accordance with the present disclosure.

### DETAILED DESCRIPTION OF THE DISCLOSURE

As utilized herein the terms “circuits” and “circuitry” refer to physical electronic components (“hardware”) and any software and/or firmware (“code”) which may configure the hardware, be executed by the hardware, and or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “example” means serving as a non-limiting example, instance, or illustration. As utilized herein, the terms “for example” and “e.g.,” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

Certain embodiments of the present disclosure may be found in methods and systems for communication with a mobile virtual base station, as described below in more detail for example with reference to the attached figures. In particular, communication systems and methods are provided for establishing wireless broadband data communication between a moving object (e.g., train), comprising one or more mobile communication devices, and base stations arranged along the path (e.g., train track) travelled by moving object. Use of such communication systems and/or methods may enable minimizing the effort required for mobile devices moving together in large groups and for the communication system in the transfers of connections.

In some example embodiments, a communication method may be used in a cellular communication system with fixed base stations, whereby a fixed base station may be selected on the basis of the location and/or movement of a group of mobile devices that are connected to a virtual base station; and signals of the virtual base station may be sent from the selected fixed base station.

In some example embodiments, a communication method may be used in a cellular communication system with fixed base stations, whereby a fixed base station may be selected on the basis of the location and/or movement of a means of transport (e.g., train); signals of the virtual base station may be sent from the selected fixed base station.

In some example embodiments, a communication system may be used, which may comprise one or more fixed base stations that may be used in wireless communication with mobile devices. The one or more fixed base stations may be configured for sending signals of virtual base stations. The communication system may comprise a selection device, configured for selecting a fixed base station on the basis of the location and/or of the movement of a group of mobile devices or of a means of transport (e.g., train). The communication system may also comprise a control device, configured for triggering the transmission of signals of the virtual base station from the selected base station.

Use of the virtual base stations in this manner—that is, for a group of mobile devices with the same movement or for a means of transport—may make it is possible to create a virtual base station that is comparable to a fixed base station and which, during the common movement of the group of mobile devices, may accompany the movement of the group of mobile devices. Thus, the complexity for the communication system may be minimized while simultaneously allowing the mobile devices to move between fixed base stations without any transfers of connection. Initiating the change of the virtual base station in the communication system may make it possible to take into account many parameters for selecting the next base station, which may not be possible if the mobile device selects the base station with the strongest signal. Such parameters may comprise, for example, the load factor, the quality of the connection, the length of the possible connection for a predicted trajectory of the group of mobile devices, etc.

In one example embodiment, a fixed base station may be selected on the basis of the location and/or of the movement of a group of mobile devices that are connected with a virtual base station.

In one example embodiment, fixed base stations may be selected sequentially such that the virtual base station accompanies the group of mobile devices. Thus, the mobile devices that are logged in with the virtual base station may not need to request any transfers of connection between base stations during their movement, since the mobile devices always see the same base station, namely the virtual base station, which accompanies them while they move.

In some example embodiments, after selecting the fixed base station, a switch to the selected fixed base station from another fixed base station may be performed, with the selected fixed base station then emitting signals of the virtual base station allocated to the group of mobile devices.

In one example embodiment, after selecting the fixed base station, the transmission of signals of the virtual base station allocated to the group of mobile devices may be stopped by the other fixed base station. Thus, the switch of the emitting base station may be achieved, in that the signals of the virtual base station are no longer sent from the other fixed base station, and are instead now being emitted from the selected base station.

In one example embodiment, the other fixed base station may switch to an idle state after the transmission of the signals of the virtual base station has stopped. Thus, a fixed base station that is intended for transmission of a virtual base station may be operated in an operating mode only for the time during which the virtual base station is transmitting from that fixed base station. Afterwards, the fixed base station can again be put into an idle state, allowing the system to be operated in an energy-saving manner.

In one embodiment, the other fixed base station switches over to an idle state after the transmission of the signals of the virtual base station has stopped, if the other fixed base station no longer sends any further signals of any other virtual base stations.

In one example embodiment, the selected fixed base station may switch from an idle state to an operating state before the transmission of the signals of the virtual base station is started. In this regard, since the selection of a fixed base station occurs a short time before the transmission of the signals of a corresponding virtual base station from the fixed base station is started, there may be time for switching the fixed base stations into an idle mode (or any other similarly energy-saving mode), since within the time span between the selection and the beginning of the transmission there is sufficient time for switching the selected fixed base station into an operating mode.

In one example embodiment, the signals of the virtual base station may be configured in such a way that a mobile device connected with the virtual base station may not need to effect a transfer of connection if the signals of the virtual base station are sent from two different sequentially selected base stations. Thus, the mobile devices connected with the virtual base station may always see the same base station, namely the virtual base station, which moves together with the mobile devices.

In some example embodiments, establishing a virtual base station may comprise generating the virtual base station; determining a specific fixed base station for first transmission of the signals of the virtual base station; and sending the signals of the virtual base station from the specific fixed base station. The virtual base station must be generated once and transmitted for the first time from the specific fixed base station. Subsequently, the movement of the virtual base station may happen automatically on the basis of the movement of the group of mobile devices that are connected with the base station. The movement of the virtual base station may cause the mobile devices to automatically log out of the virtual base station (and log into another virtual or fixed base station) that have moved too far away relative to the virtual base station so that they may not have connection anymore to the virtual base station. Simultaneously, the mobile devices will automatically gradually log into the virtual base stations that have the same movement as the virtual base station.

In one example embodiment, determining the specific fixed base station for the first transmission of the signals of the virtual base station may comprise detecting a group of mobile devices on the basis of a common movement, and determining the fixed base station on the basis of a current and/or future location of the detected group of mobile devices. Thus, it may be possible to generate in a targeted manner virtual base stations where they are needed.

In one example embodiment, the specific fixed base station for the first transmission of the signals of the virtual base station may be selected in the vicinity of transport hubs. Thus, the communication system may not need to detect the movement of all mobile devices in order to generate a virtual base station. In this regard, groups with the same movement may usually form in transport hubs. In instances where a virtual base station is generated at such a hub for transport (e.g., at a railway station), or in its vicinity, the virtual base station may follow, such as after a certain time, a small group of mobile devices that have connected to the virtual base station. In instances where the group of mobile devices may be or may become in company of other mobile devices, the latter may all gradually log into the virtual base station, since it may continuously provide a good connection. In this regard, the virtual base station may be transmitted from a fixed base station close to the transport hub removed from it in the direction of a means of transport's leaving trajectory, so that the signals when leaving the transport hub may become stronger. When different virtual base stations in different fixed base stations that are placed respectively at different leaving trajectories of the transport hub and removed from it, are transmitted, a mobile device moving away from the transport hub on the leaving trajectory automatically logs into the ever stronger signal of the corresponding virtual base station.

In one example embodiment, determining the specific fixed base station for the first transmission of the signals of the virtual base station may comprise detecting a means of transport (e.g., train), and determining the fixed base station on the basis of a momentary and/or future location of the means of transport. Thus, it may be possible to generate a virtual base station for each means of transport that has not been allocated any virtual base station yet.

In one example embodiment, the virtual base station may be deleted based on one or more conditions or criteria—e.g., if fewer than a specified number of mobile devices are connected with the virtual base station, or in the event that fewer than a specified number of mobile devices are connected for longer than a certain time with the virtual base station. The deletion may be performed by weakening the signal of the virtual base station so that mobile devices that are still connected with the virtual base station perform a handover to a fixed or to another virtual base station.

In one example embodiment, the communication system may send information for the mobile devices connected with the virtual base station to the fixed base stations, and the selected fixed base station may send the received information with the signals of the virtual base station. Thus, the communication system may need to make no administrative effort in order to monitor which fixed base station currently hosts the virtual base station. The information for the virtual base station may be transmitted to several base stations simultaneously (e.g., in multicast manner), so that the selected base station may require only the identification information of the virtual base station in order to retrieve from the multicast network the information to be transmitted of the virtual base station.

In one example embodiment, the communication system may be a mobile telephone network. In this regard, the communication methods and/or systems described may be particularly advantageous for mobile telephone networks, since it is particularly in this context that the problem of group movement of mobile devices often arises.

In one example embodiment, a fixed base station may be configured for transmitting signals of a plurality of virtual base stations simultaneously.

In one example embodiment, a fixed base station may be configured for transmitting simultaneously with the signals of a virtual base station signals allocated to the fixed base station.

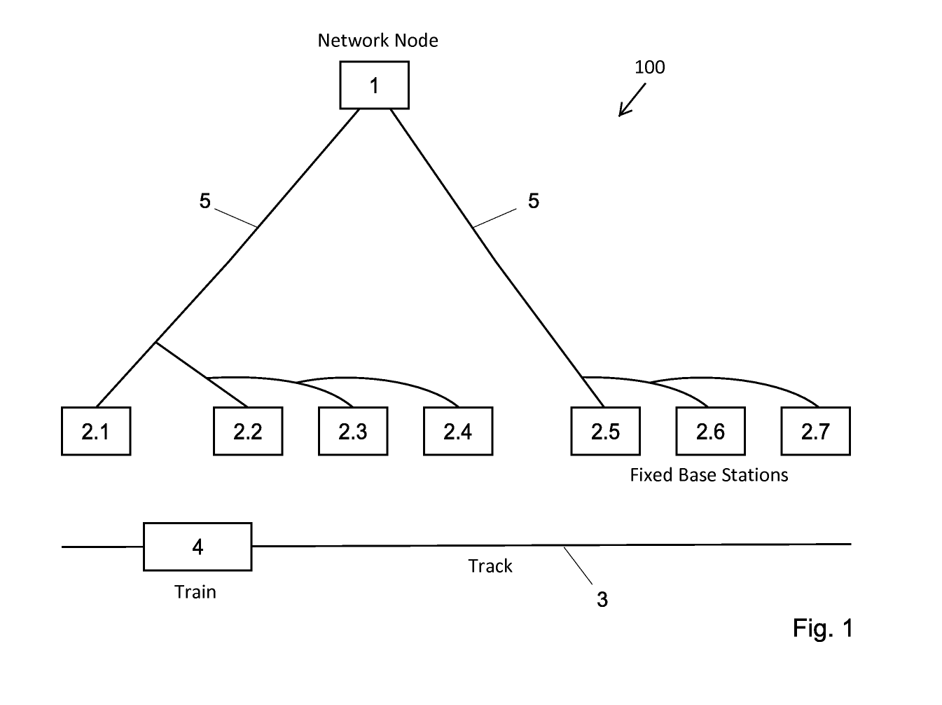

FIG. 1 illustrates a view of an example communication system. Shown in FIG. 1, is a communication system that comprises a plurality of fixed base stations 2 (e.g., fixed base stations 2.1 to 2.7), which may be connected with one or more network nodes 1 of the communication system (e.g., via one or more connections 5).

The communication system 100 may be, for example, a mobile communication network or mobile telephone network such as GSM, GPRS, UMTS, LTE or any other suitable mobile communication standard for supporting mobile communications. The present disclosure is not limited, however, to mobile telephones, and may be applied in substantially similar manner to other technologies, such as Wireless Local Area Networks (WLAN), Wide Area Networks (WAN) or other wireless cellular or types of communication systems.

Each of the plurality of fixed base stations 2 and the one or more network nodes 1 may comprise suitable circuitry for implementing various aspects of the present disclosure.

The plurality of fixed base stations 2 may comprise a plurality of access points which may be configured for connecting mobile devices of the communication system 100 via wireless connections to the network nodes 1 and/or vice versa. Each fixed base station 2 may cover a specific transmission area, depending on the transmission characteristics of the fixed base station 2 and/or on the local conditions for example.

In various example implementations, the plurality of fixed base stations 2 may be arranged locally so that the transmission areas of the plurality of fixed base stations 2 together cover a specific (aggregate) transmission area. For example, the aggregate transmission area may correspond to, for example, a track 3 of a specific railway line or a track network for a train service in a certain area. Nonetheless, it should be understood that disclosure is not so limited, and that a same or similar approach as described herein may be used in other settings—e.g., to create transmission areas along motorways, rivers and other traffic ways and by other means of transportation (such as e.g., cars, boats, etc.). Further, while not particularly shown in FIG. 1, the communication system 100 may also comprise further fixed base stations 2 that are not in the vicinity of the track 3.

In legacy systems, each fixed base station may be configured to transmit a signal associated with that fixed base station. On the basis of this signal associated with the fixed base station, a mobile device may identify the corresponding fixed base station, and distinguish it from other base stations. Thus, the mobile device may decide, based the different signals of different base stations, with which base station to connect. In various implementation of the present disclosure, however, the plurality of fixed base stations 2 may be configured for sending a signal associated with one or more virtual base stations. In this regard, the signals may be configured such that they appear to a mobile device logged into the virtual base station as always coming from the same base station, namely the virtual base station, regardless of from which fixed base station 2 these signals of the virtual base station are sent. For example, in the example implementation depicted in FIG. 1, the fixed base station 2.2 is close to a train 4 and the fixed base station 2.2 transmits signals of a virtual base station.

In an example implementation, the plurality of fixed base stations 2 may be configured for sending both signals associated with the corresponding fixed base station 2 as well as signals of at least one virtual base station. In another example implementation, however, the plurality of fixed base stations 2 may be configured for only transmitting signals of at least one virtual base station without sending signals associated with the corresponding base station. In a further example implementation, the plurality of fixed base stations 2 may comprise at least one fixed base station that is configured to transmit both its own signals as well as signals of at least one virtual base station as well as at least one fixed base station that is configured to only send signals of at least one virtual base station. In some example implementations, regardless of the capability to only transmit signals of at least one virtual base station or to transmit its own signals as well as signals of at least one virtual base station, at least one of the fixed base station 2 may be configured to additionally transmit signals of at least one further (e.g., second) virtual base station.

The fixed base stations 2 may be connected by means of an optical point-to-point connection with a network node. In some example implementations, however, a multicast network is used for connecting several fixed base stations 2 with the network node 1. Such network may comprise, for example, a passive optical network (PON). The multicast network may be configured for delivering similar information to one or more sets of the fixed base stations. For example, in the implementation depicted in FIG. 1, such multicast network may be configured to deliver over the connection(s) 5 (first) same information to a first set of the fixed base stations 2 (e.g., fixed base stations 2.1, 2.2, 2.3 and 2.4), and (second) same information to a second set of the fixed base stations 2 (e.g., fixed base stations 2.5, 2.6 and 2.7). Thus, the first set of the fixed base stations 2 (e.g., fixed base stations 2.1, 2.2, 2.3 and 2.4) may be located in a first branch of the network, and the second set of the fixed base stations 2 (e.g., fixed base stations 2.5, 2.6 and 2.7) may be located in the second branch of the network. It should be understood, however, that the disclosure is not so limited, and that any other number of fixed base stations 2 in a branch and any other number of branches are possible. Configuring a network in the communication system 100 in such a manner may be advantageous as no administrative effort may need to be made in order to monitor which fixed base station 2 currently hosts the virtual base station in order to send the correct information to the selected fixed base stations 2. The information for the virtual base station may be sent simultaneously to several base stations 2 (multicast). Thus, the selected base station (e.g., fixed base station 2.2) may only need identification information of the virtual base station in order to retrieve from the multicast network the information to be transmitted of the virtual base station. Thus, all information about all virtual base stations active in the plurality of fixed base stations 2.1 to 2.4 is sent to all these fixed base stations 2.1 to 2.4.

A switch of the virtual base station among the plurality of fixed base stations 2 (e.g., from fixed base station 2.2 to fixed base station 2.3) is thus possible with a very low administrative effort for the communication system 100. The multicast network could also exist additionally to a point-to-point connection with the network nodes 1. This would enable information for a signals associated with the fixed base station 2 to be transmitted via the point-to-point connection to that fixed base station 2, while the information for the virtual base stations may be sent over the multicast network 5 to the plurality of fixed base stations 2. Nonetheless, in some implementations it may be also possible to transmit the information for the virtual base station via point-to-point connections to the selected fixed base station 2.

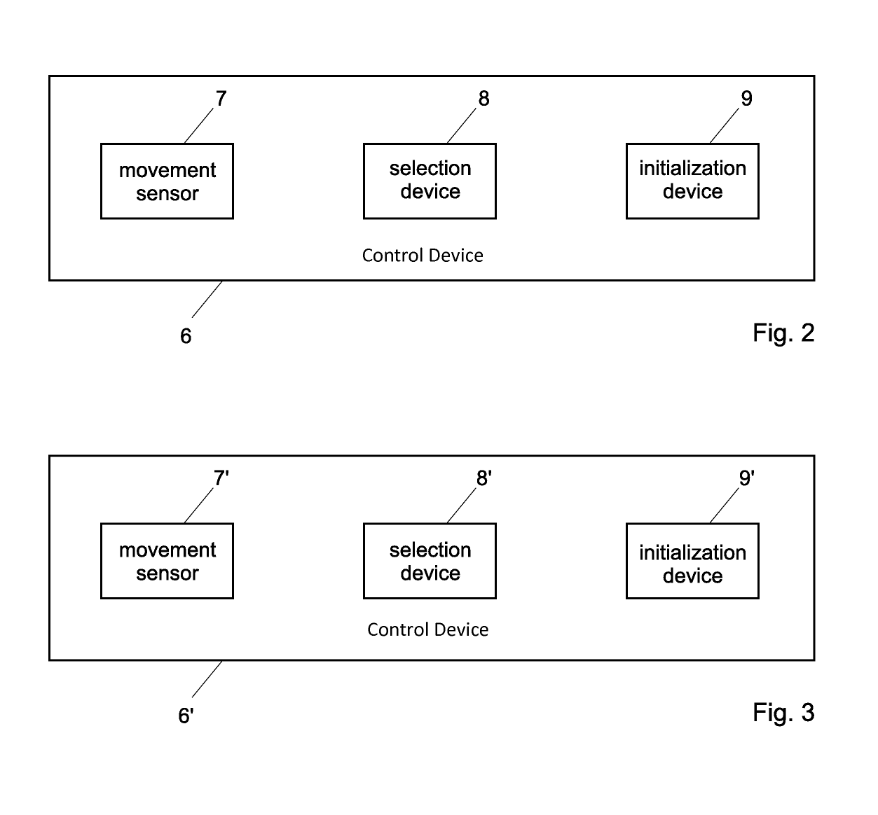

FIG. 2 illustrates an example control device of a communication system, in accordance with the present disclosure. Shown in FIG. 2 is an example control device 6, which may be used in a communication system, such as the communication system 100 of FIG. 1.

The control device 6, and any component thereof, may comprise suitable circuitry for implementing various aspects of the present disclosure. For example, as shown in FIG. 2, the control device 6 may comprise a movement sensor 7, a selection device 8, and an initialization device 9. The control device 6 and/or its sub-components may be placed and/or implemented centrally and/or de-centrally in communication systems. For example, the control device 6 and/or its sub-components may be placed centrally in the communication system 100, de-centrally in the fixed base stations 2, in-between in the network nodes 1, and/or distributed over a central location, the network nodes 1 and/or the fixed base stations 2.

The movement sensor 7 may be configured for detecting location and/or movement of mobile devices. In this regard, the location of mobile devices may be determined in one or more ways. For example, the location of a mobile device may be determined by triangulation of signals sent between different base stations. The location of the mobile device may also be determined (e.g., as rough estimate) based on the used fixed base station 2—e.g., the fixed base station 2 as a factor of the time of logging into or out of this fixed base station 2 respectively, and/or if the mobile device is connected with a virtual base station, as a factor of time the fixed base station 2 is transmitting as the virtual base station,. The movement of mobile devices may be determined in one or more ways. For example, movement of a mobile device may be detected simply by continually determining the location over time of that mobile device.

The selection device 8 may be configured for selecting a particular fixed base station 2 into whose transmission area a group of mobile communication devices connected with a virtual base station enters or will enter. For example, the selection device 8 may be configured to select the particular fixed base station 2 on the basis of the location and/or of the movement of the group of mobile devices. In this regard, the selection device 8 may receive from the movement sensor 7, the location and/or movement of the mobile devices that are logged into a virtual base station. Alternatively, in some instances it may be sufficient to receive the location and/or movement of a representative subgroup of the mobile devices that are logged into the virtual base station. In this regard, it may be possible to determine the movement of the entire group/subgroup from the movement of the mobile devices representative of the group/subgroup—e.g., by averaging, median calculation or other functions of the individual movements.

In one example implementation, the selection may be made as soon as the group of mobile devices is located in a transition zone between a first fixed base station 2 that is transmitting the signals of the virtual base station and at least a second fixed base station 2, into whose transmission area the group of mobile devices enters. In another example implementation, the selection may be made already before reaching the transition zone and/or before the virtual base station is switched. This has the advantage that the selected fixed base station 2 may be informed already prior to the switch of the virtual base station and that a seamless transition of the virtual base station between two fixed base stations 2 may be prepared—e.g., awakening the fixed base station 2 from its idle state. In the event that, at the location of the switch or of the predicted switch of fixed base station 2 that transmits to the virtual base station, there is more than one fixed base station 2 with a good signal that can be considered, the selection may then also take into account an estimate of the future trajectory of the group of mobile devices in order to determine the next fixed base station 2 for transmitting the signals of the virtual base station. The future route can in one example implementation be estimated on the basis of the trajectory so far.

In an example implementation, the future route can be estimated on the basis of the previous trajectory in combination with data from other groups of mobile communication devices that have chosen the same or a similar previous route.

In an example implementation, the future route can be estimated on the basis of the prior trajectory in combination with data about traffic infrastructure.

In an example implementation, the future route can be estimated on the basis of a detected means of transport with a known future trajectory. The means of transport can be identified for example on the basis of the location of the group, wherein the location of the group is compared with locations of known means of transport in order to detect the means of transport. The knowledge of the future route can be taken into account for selecting the next fixed base station 2 for transmitting the signals of the virtual base station—e.g., by means of a plan of the fixed base stations, where the fixed base station 2 allows also for the future route the best connection quality and/or the longest possible connection with the fixed base station 2. For the selection, other parameters of the fixed base stations 2, such as e.g., the load, can also be taken into account. A base station may possibly be optimal for the connection due to its location, but cannot guarantee a secure connection due to the high load. Thus, an alternative fixed base station 2 may be selected, which although it has a worse location, the lower load may ultimately provide a better connection quality.

The initialization device 9 may be configured for determining the point in time that a virtual base station is generated and/or the fixed base station 2 that is used in generating a virtual base station. The communication system may decide about the generation of virtual base stations. The virtual base station is not generated upon request of a mobile device. Examples for the initialization device 9 will be described in more detail below.

In operation, the control device 6 may be configured for generating, deleting and/or administering virtual base stations, and for giving commands to the fixed base stations 2 for transmitting signals of the virtual base stations. In this regard, a virtual base station may be generated when the initialization device 9 decides that the virtual base station is to be created, as described below. For this purpose, the initialization device 9 may hand over the fixed base station 2 and possibly communicate the moment in time the virtual base station is generated.

The administration of a virtual base station may comprise, for example, allocating the mobile devices connected with the virtual base station and allocating the virtual base station with one or more fixed base stations 2, from which the virtual base station is transmitted. For example, the signals of the virtual base stations may be transmitted from the fixed base stations 2 connected with the mobile-services switching centers (MSC) and are included in the visitor location registers (VLR) of the mobile services switching centers (MSC). In this regard, the network node 1 may be an MSC. Thus, it may be sufficient to store an allocation of each and every virtual base station with one or more fixed base station 2 transmitting the corresponding virtual base station. In this regard, the mobile devices may independently log into a virtual base station transmitted by a fixed base station 2 if its signal is the strongest, or if other decision criteria (of the standard) result in favorable selection of the virtual base station. The control device 6 may enable monitoring currently connected mobile devices of each and every virtual base station. The administration of a virtual base station may also comprise allocating the virtual base station to a new fixed base station 2 when the selection device 8 decides to switch the fixed base station 2.

The control device 6 may delete a virtual base station, such as when certain conditions or criteria (for deletion) are fulfilled or met. In this regard, the virtual base station may be deleted only after the virtual base station has been shut down in an orderly manner. For example, shutting down may occur, for example, through a continuous weakening of the signal so that the mobile devices logged into the virtual base station automatically perform a handover to another virtual base station or to a fixed base station 2, as soon as their signal is stronger than that of the virtual base station being shut down. Example of conditions or criteria for deletion may comprise the number of the mobile devices connected with the virtual base station dropping below a specified threshold (e.g., minimum number of mobile devices). Another condition for deletion may be the control device 6 detecting that two virtual base stations have mobile devices with the same movement, and as such the control device 6 may cause one of the two virtual base stations to be shut down and deleted. Another condition for deletion may be that the virtual base station moves, since the administration of a stationary virtual base station does not make sense.

The control device 6 may be configured for sending to the fixed base stations 2 instructions to start transmitting signals of a specific virtual base station, or to stop ongoing transmission of the signals of a specific virtual base station. These instructions may be generated on the basis of, for example, allocating the fixed base station 2 to the virtual base station in the control device 6. Thus, the control device 6 may cause the virtual base station to be switched to the fixed base station 2 selected in the selection device 8.

In an example virtual base stations switching scenario, with reference to the communication system 100 of FIG. 1, transmission of signals of virtual base station may be switched from a fixed base station (e.g., the fixed base station 2.2) that is currently transmitting the signals of the virtual base station to a selected (another) fixed base station (e.g., the fixed base station 2.3). In this regard, the transmission of the signals of the virtual base station from the fixed base station 2.2 may be interrupted at the same time as the transmission of the signals of the virtual base station from the fixed base station 2.3 is started. A momentarily simultaneous transmission of the signals of the virtual base station from both fixed base stations 2.2 and 2.3 may also possible. In the case of a momentarily simultaneous transmission of the signals of the virtual base station, on the one hand the signals to be transmitted are sent to the two fixed base stations 2.2 and 2.3 by the network node 1 and, on the other hand, the data from the uplink is received in duplicate at the two fixed base stations 2.2 and 2.3.

All the mobile devices connected with the virtual base station automatically switch fixed base station 2 along their trajectory without having to request a transfer of the connection. The mobile devices being connected with the virtual base station and moving together with the virtual base station, remain connected to the same virtual base station while they communicate along their displacement with different fixed base stations 2. It may thus also be possible to predict in the network that a connection quality from one fixed base station 2 may possibly be momentarily worse than that of another fixed base station 2, yet because of the subsequent good connection quality a switching of the fixed base station 2 may not make sense. Thus, it may be possible to strategically plan for transferring the connections. Further, use of the virtual base stations in this manner may allow for continued handing over of connection but without requiring any change of existing mobile communication standards since the mobile devices need not distinguish the virtual base stations from fixed base stations 2.

In one example implementation, the initialization device 9 may query the movement sensor 7 for the location and/or the movement of mobile devices in a specific spatial area. The initialization device 9 may determine from the locations and/or movements of the mobile devices a group of mobile devices that have a similar movement pattern. For example, determining such a group of mobile devices may be achieved by detecting the same direction of movement of mobile devices that find themselves at a certain distance to one another. However, such detecting may be complex and time-consuming. Alternatively, a group of mobile devices with a common pattern of movement may be detected in that these mobile devices at sequential fixed base stations 2 log into the respective fixed base station 2 more or less simultaneously.

In an example implementation, certain fixed base stations 2 are selected randomly (e.g., by the initialization device 9) for generating a virtual base station. If a selected fixed base station 2 transmits a newly generated virtual base station and a train passes the transmission area of this fixed base station 2, some of the mobile devices log into the new virtual base station. Thus the group of mobile devices that are logged into the virtual base station moves together with the train. On the basis of the movement of the mobile devices logged into the virtual base station, a next fixed base station 2 located along the movement of the train may be selected in the selection device 8. The newly generated virtual base station thus automatically moves with a train that travels past the fixed base station 2 selected for generating the virtual base station. Step by step, the remaining mobile devices in the train may also choose this virtual base station as a preferred base station, since the latter provides continuously a good signal. Should the number of the mobile devices logged into the virtual base station not reach a minimum number of mobile devices after a specific time span, the control device 6 may delete this virtual base station again. Accordingly, it may be possible to generate virtual base stations in a self-organized fashion without great detection effort, although only those virtual base stations that have enough mobile devices may survive.

In some instances, instead of randomly selecting the fixed base station 2 and/or the moment in time for generating the virtual base station in the initialization device 9, the selection may also occur in terms of time and/or location on the basis of the timetable of the means of transport and/or on the basis of the detection of the means of transport. The means of transport may be localized through an interface (not shown) with the operator of the means of transport or directly on the basis of the signals of the means of transport. For example, a train may be detected by means of its signals in the train mobile communication network—e.g., the Global System for Mobile Communications-Railway (GSM-R). Thus, it may be possible to generate a virtual base station at locations where the means of transport will be passing.

In some implementations, the initialization device 9 may cause a virtual base station to be generated in certain situations in a targeted fashion. In this regard, it may be possible to detect that the group of mobile devices that are connected with a virtual base station has subgroups that move in different main directions—e.g., a first subgroup moving in one main direction and a second subgroup that remains stationary. This may be caused by characteristics of the transportation systems—e.g., occurring at important transfer or connection points of a railway network. Thus, the virtual base station may follow one subgroup that moves in one main direction while at location of the second subgroup (e.g., stationary location of a stationary subgroup, or at the location in the direction of which the second subgroup is moving) a new virtual base station is caused to be created.

In some example implementations, various mechanisms for generating virtual base stations may be supported and/or combined.

While selection of the next fixed base station may be decided on the basis of the movement of the mobile devices logged into the virtual base station, so that the virtual base station automatically follows the mobile devices located in a means of transport, the disclosure is not so limited. For example, it is also possible, alternatively, to determine the selection of the next fixed base station directly on the basis of the location and/or of the movement of the means of transport. In this implementation, the virtual base station is allocated directly to a specific means of transport. Such implementations are described in more detail below.

FIG. 3 illustrates an alternate example control device of a communication system, in accordance with the present disclosure. Shown in FIG. 3 is an example control device 6′, which may be used in a communication system, such as the communication system 100 of FIG. 1. In this regard, the control device 6′ may represent an alternative implementation to the control device 6 of FIG. 2.

The control device 6′, and any component thereof, may comprise suitable circuitry for implementing various aspects of the present disclosure. For example, as shown in FIG. 3, the control device 6′ may comprise a movement sensor 7′, a selection device 8′, and an initialization device 9′. Inasmuch as not described otherwise, the functions of each of the control device 6′, the movement sensor 7′, the selection device 8′, and the initialization device 9′ may be substantially similarly to the corresponding elements in FIG. 2—that is the control device 6, the movement sensor 7, the selection device 8, and the initialization device 9.

The movement sensor 7′ may be configured for detecting the location and/or the movement of a means of transport (e.g., train 4, along track 3). For example, the location and/or the movement may be detected on the basis of information provided via an interface with the operator of the means of transport, or on the basis of signals of the means of transport. A train as means of transport may be detected, for example, by its signals in the train mobile communication network (e.g., GSM-R based network).

The selection device 8′ may be configured for selecting, on the basis of the location and/or of the movement of a means of transport, the next fixed base station into whose transmission area the means of transport enters or will enter. In this regard, the selection device 8′ may obtain from the movement sensor 7′ the location and/or movement of a means of transport. For the selection, the future trajectory of the means of transport may be taken into account. The future route may be determined in the event of a possible identification of the means of transport on the basis of the timetable of the means of transport. Alternatively, the future route may be received directly from signals of the means of transport.

The initialization device 9′ may be configured for controlling the generation of virtual base stations—e.g., determining the moment in time and/or the fixed base station 2 for the generation of a new virtual base station. For example, the moment in time and/or the fixed base station 2 from which the virtual base station is to be transmitted for the first time may be selected on the basis of the starting point or any other location of a means of transport. The starting point or other location may be chosen according to the timetable of a means of transport or according to information from the operator of the means of transport. In some implementations, it may also be possible to detect means of transport, at least at certain points of a transport network, via the movement sensor and select a fixed base station for transmitting the new virtual base station at the location of the means of transport.

The control device 6′ may be configured such that it may function to a large extent like the control device 6. Nonetheless, the control device 6′ may be configured to particularly operate, at least in part, on the basis of the means of transport (e.g., train 4) itself. Thus, the virtual base station may be deleted in the control device 6′ if the means of transport has reached its destination, regardless of the log status of the mobile devices therein.

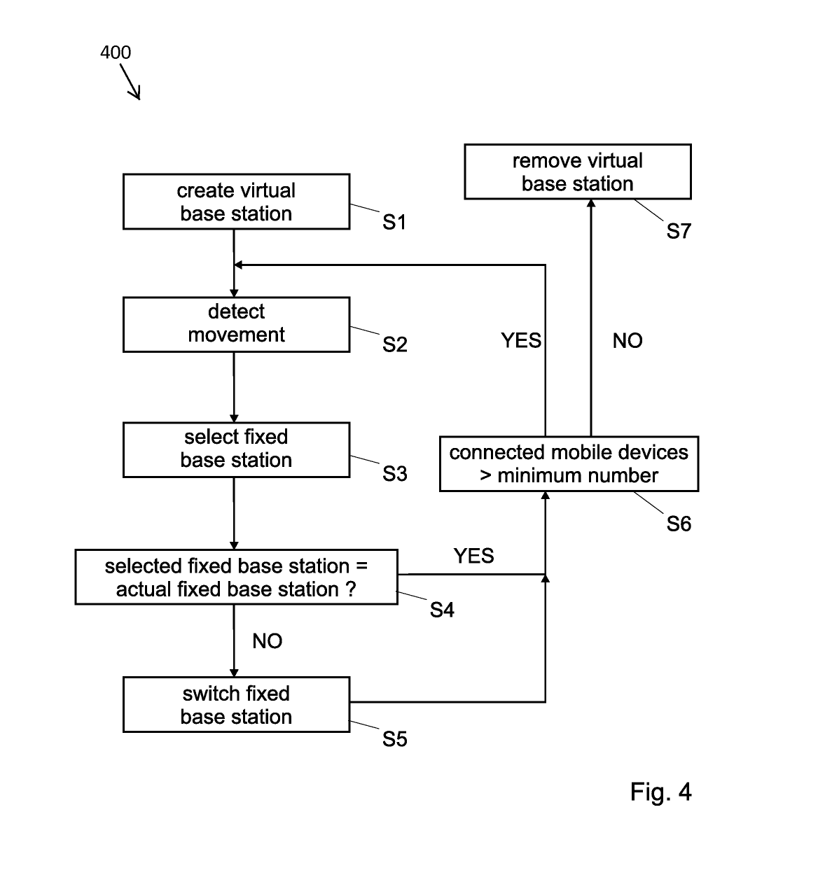

FIG. 4 is a flow chart illustrating an example process, in accordance with the present disclosure. Shown in FIG. 4 is a flow chart 400, comprising a plurality of example steps, which may be performed in a communication system (e.g., the communication system 100 of FIG. 1) for controlling the virtual base stations.

In step S1, a virtual base station may be generated, as described with respect to FIGS. 1-3, for example. The generation of the virtual base station may comprise, for example, such actions or operations as determining a specific fixed base station (e.g., one of the fixed base stations 2) for transmitting as the virtual base station, depending on the particular implementation being used. The specific fixed base station may be determined (or selected), for example, on the basis of a group of mobile devices moving together being detected, on the basis of a means of transport being detected, on the basis of the timetable of a means of transport and/or on a random basis. The signals of the virtual base station may be transmitted from the specific fixed base station.

In step S2, the movement and/or location of a group of mobile devices logged into the virtual base station or of a means of transport may be determined. The manner by which the determination is made may depend on the particular implementation being used, as described with respect to the previous figures for example.

In step S3, a new fixed base station (another one of the fixed base stations 2) may be selected. The new fixed base station may be selected adaptively, depending on the particular implementation being used, as described above. For example, the fixed base station may be selected on the basis of the specific movement or specific location, as described in relation with the selection device 8 or 8′.

In step S4, it may be verified whether the new fixed base station is the same as the fixed base station that is currently transmitting the signals of the virtual base station (that is the fixed base station previously determined in step S1). In instances where it is determined that the newly selected fixed base station is not the same, the process may proceed to step S5, to facilitate switching the fixed base station used in transmitting as the virtual base station. Otherwise, in instances where it is determined that newly selected fixed base station is the same fixed base station currently transmitting the virtual base station, the process may proceed directly to step S6.

In step S5, the fixed base station transmitting as the virtual base station may be switched to the newly selected fixed base station—that is the fixed base station selected in step S3. For example, to effectuate the switch to the newly selected fixed base station, the sending of the signals of the virtual base station from the currently transmitting fixed base station may be interrupted and the sending of the signals of the virtual base station of the newly selected fixed base station may be started. The process may then continue to step S6.

In step S6, it may be verified whether any virtual base station deletion condition occurred. For example, a verification whether a specified minimum number of mobile devices remained logged into the virtual base station, such as for particular duration, may be performed. If this is not the case over a specific period of time, the virtual base station may be shut down and deleted and the transmission of its signals is stopped. Otherwise, if there is a sufficient number of mobile devices logged into the virtual base station or if the minimum period of time has not been exceeded yet, the process may continue—e.g., by looping back to step S2.

Other embodiments of the disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein.

Accordingly, the present disclosure may be realized in hardware, software, or a combination of hardware and software. The present disclosure may be realized in a centralized fashion in at least one computer system, or in a distributed fashion where different units are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure makes reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present disclosure not be limited to the particular embodiment disclosed, but that the present disclosure will include all embodiments falling within the scope of the appended claims.

What is claimed is:

1. A method, comprising:
emitting signals of a virtual base station from a first fixed base station;
selecting a second fixed base station on the basis of location and/or of movement of a group of mobile devices;
switching emission of signals of the virtual base station from the first fixed base station onto the second fixed base station.

2. The method according to claim 1, comprising selecting further fixed base stations sequentially for emission of signals of the virtual base station such that the virtual base station accompanies the group of mobile devices.

3. The method according to claim 1, comprising selecting the second fixed base station on the basis of the location and/or of the movement of a group of mobile devices that are logged into the virtual base station.

4. The method according to claim 1, comprising determining the location and/or the movement of the group of mobile devices on the basis of location and/or of movement of a means of transport.

5. The method according to claim 1, comprising stopping, after beginning of transmission of the virtual base station from the second fixed base station, transmission of signals of the virtual base station from the first fixed base station.

6. The method according to claim 5, comprising switching the first fixed base station, after the transmission of the signals of the virtual base station is stopped, into an idle state, when the first fixed base station does not emit any further signals of a further virtual base station.

7. The method according to claim 1, comprising switching the second fixed base station, prior to beginning of transmission of the virtual base station switches, from an idle state into an operating mode.

8. The method according to claim 1, wherein the signals of the virtual base station are configured so that a mobile device from the group of mobile devices connected with the virtual base station remains connected with the virtual base station when the signal transmission of the virtual base station switches from the first fixed base station onto the second fixed base station.

9. The method according to claim 1, comprising creating the virtual base station, wherein creating the virtual base station comprises:
generating the virtual base station;
determining the first fixed base station for first transmission of the signals of the virtual base station; and
emitting signals of the virtual base station from the determined first fixed base station.

10. The method according to claim 9, comprising determining the first fixed base station for the first transmission of the signals of the virtual base station based on detecting a group of mobile devices on the basis of a common movement, and determining the fixed base station on the basis of a current and/or future location of the group of mobile devices.

11. The method according to claim 9, comprising determining the first fixed base station for the first transmission of the signals of the virtual base station based on detecting a means of transport, and determining the fixed base station on the basis of a current and/or future location of the means of transport.

12. The method according to claim 1, wherein the communication system sends information for the mobile devices connected with the virtual base station to several fixed base stations, and the second fixed base station emits the received information with the signals of the virtual base station.

13. A non-transitory machine-readable storage having stored thereon, a computer program having at least one code section, the at least one code section being executable by a machine for causing the machine to perform steps comprising:
emitting signals of a virtual base station from a first fixed base station;
selecting a second fixed base station on the basis of the location and/or of the movement of a group of mobile devices;
switching the place of emission of the signals of the virtual base station from the first fixed base station onto the second fixed base station.

14. A communication system, comprising:
one or more fixed base stations for wireless communication with mobile devices, wherein the one or more fixed base stations are configured for transmitting signals of a virtual base station;
a selection device configured for selecting a fixed base station on the basis of the location and/or of the movement of a group of mobile devices; and
a control device configured for triggering the sending of signals of the virtual base station from the selected fixed base station.

15. The communication system according to claim 14, wherein the selected fixed base station is configured for transmitting signals of several virtual base stations simultaneously.

16. The communication system according to claim 14, wherein the selected fixed base station is configured for transmitting simultaneously with the sending of the signals of the virtual base station signals that are associated with the selected fixed base station.
